(19) United States
(12) Patent Application Publication
(10) Pub. No.: US 2026/0154761 A1
(43) Pub. Date: Jun. 4, 2026

(54) SYSTEMS AND METHODS FOR RADIO FREQUENCY-BASED TRANSACTIONS

(71) Applicant: Mastercard International Incorporated, Purchase, NY (US)

(72) Inventors: Shawn Mehrhoff, Sappington, MO (US); Christopher T. Scholl, Manchester, MO (US); David Vorhies, Saint Charles, MO (US)

(73) Assignee: Mastercard International Incorporated, Purchase, NY (US)

(21) Appl. No.: 18/967,342

(22) Filed: Dec. 3, 2024

(51) Int. Cl. G06Q 50/06; B60L 53/57; B60L 53/66; G06K 7/14; G06Q 20/32; H04W 4/46

(52) U.S. Cl. CPC G06Q 50/06; B60L 53/57; B60L 53/665; G06Q 20/325; H04W 4/46; G06K 7/1417

(57) ABSTRACT

Techniques for facilitating electric vehicle charging include a consumer vehicle computing device in a consumer's vehicle identifying a mobile charging vehicle and scanning a machine-readable code displayed thereon. The consumer vehicle computing device detects a failure in scanning the code. The consumer selects an AM/FM radio frequency in response to the scanning failure and the consumer vehicle computing device receives a radio broadcast from the mobile charging vehicle on the selected frequency. The broadcast includes charging information. The consumer vehicle computing device transmits a charging connection message to the charging merchant, including the charging information. The consumer vehicle computing device permits the consumer vehicle to receive charging from the mobile charging vehicle.

### BACKGROUND

The field of the disclosure relates generally to electronic payment systems for vehicle charging transactions and, more specifically, to electronic payment systems using radio frequency communications for processing vehicle charging transactions between a consumer and a merchant.

The growing adoption of electric vehicles has increased demand for flexible charging solutions beyond traditional stationary charging locations. Mobile charging vehicles offer a convenient alternative, allowing consumers to receive on-demand charging services without needing to locate a stationary charging station. However, challenges such as unreliable communication, security concerns in transaction processing, and difficulties in vehicle authentication have limited the efficiency of these systems.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a system is provided. The system includes a consumer vehicle associated with a consumer. The consumer vehicle includes a consumer vehicle computing device, which includes a one or more first processors and a first memory. The first memory includes first computer-executable instructions stored thereon, which when executed by the one or more first processors, causes the one or more first processors to identify a mobile charging vehicle displaying a machine-readable code, scan the machine-readable code, and detect failure in scanning the machine-readable code. The mobile charging vehicle is associated with a charging merchant. The one or more first processors select, in response to the scanning failure, an AM/FM radio frequency in the consumer vehicle, and receive a radio broadcast transmitted by the mobile charging vehicle on the AM/FM radio frequency. The radio broadcast includes charging information. The one or more first processors also transmit a charging connection message to the charging merchant. The charging connection message includes the charging information received via the radio broadcast. The one or more first processors permit the consumer vehicle to receive charging from the mobile charging vehicle.

In another aspect, a method is provided. The method includes identifying, via a consumer vehicle computing device in a consumer vehicle, a mobile charging vehicle displaying a machine-readable code, and scanning, by the consumer vehicle computing device, the machine-readable code. The mobile charging vehicle is associated with a charging merchant. Furthermore, the method includes detecting, by the consumer vehicle computing device, failure in scanning the machine-readable code. In response to the scanning failure, the method includes selecting, by the consumer vehicle computing device, an AM/FM radio frequency in the consumer vehicle and receiving, by the consumer vehicle computing device, a radio broadcast transmitted by the mobile charging vehicle on the AM/FM radio frequency. The radio broadcast includes charging information. The method includes transmitting, by the consumer vehicle computing device, a charging connection message to a charging merchant. The charging connection message includes the charging information received via the radio broadcast. Moreover, the method includes permitting the consumer vehicle to receive charging from the mobile charging vehicle.

A variety of additional aspects will be set forth in the detailed description that follows. These aspects can relate to individual features and to combinations of features. The advantages of these and other aspects will be apparent to those skilled in the art from the following description of the exemplary embodiments which have been shown and described by way of illustration. As will be realized, the details of the present aspects described herein may be modified in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram depicting an exemplary multiparty payment card processing system and network for processing a payment transaction, including vehicle charging payment transactions, in accordance with an aspect of the present disclosure;

FIG. 2 is an example configuration of a computing system for use with the system of FIG. 1;

FIG. 3 is an example configuration of a mobile charging supplier vehicle for use with the system of FIG. 1;

FIG. 4 is an example configuration of a server system for use with the system of FIG. 1; and

FIG. 5 is a process flow diagram for a process for an electrical energy charging transaction between a consumer and a charging supplier merchant of FIG. 1, in accordance with an aspect of the present disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. It is contemplated that the invention has general application to charging electric vehicles. The scope of the present invention is defined only by the appended claims, along with the full scope of equivalents to which such claims are entitled.

### Example System

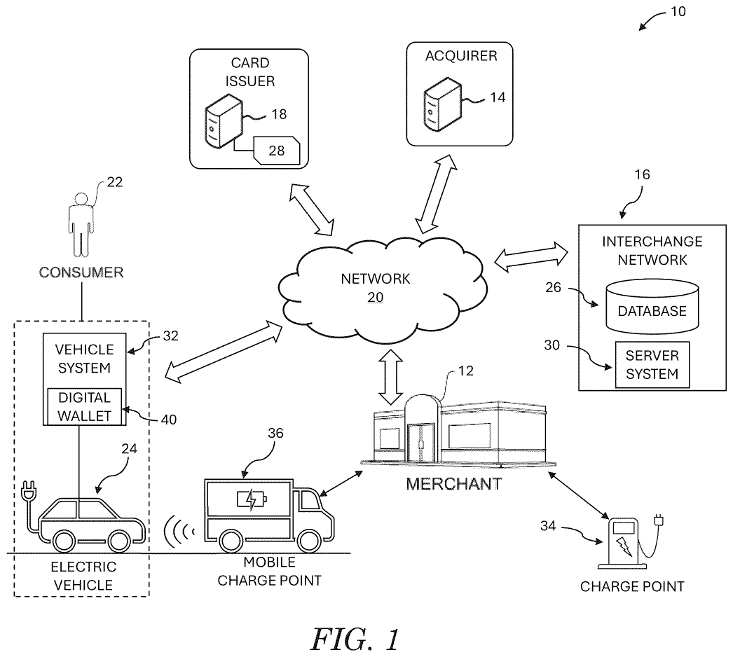

FIG. 1 is a block diagram depicting an exemplary multiparty payment card processing system and network 10 for processing payment transactions, including vehicle charging payment transactions. Embodiments described herein may relate to a transaction card system, such as a credit card payment system using the Mastercard® interchange network. (Mastercard is a registered trademark of Mastercard International Incorporated.) The Mastercard interchange network is a set of proprietary communications standards promulgated by Mastercard International Incorporated for the exchange of financial transaction data and the settlement of funds between financial institutions that are members of the Mastercard interchange network. Embodiments described herein may also relate to digital payment services such as “Click to Pay,” a unified digital payments service offered by Mastercard, or another digital wallet service for a mobile device such as a smartphone.

In the exemplary embodiment, the system 10 facilitates providing interchange network services offered by an interchange network 16. In addition, the system 10 enables payment card transactions in which a merchant 12, an acquirer 14, and/or a card issuer 18 do not need to have a one-to-one relationship. Although parts of the system 10 are presented in one arrangement, other embodiments may include the same or different parts arranged otherwise, depending, for example, on authorization processes for purchase transactions, communication between computing devices, etc.

In the example embodiment, the merchant 12, the acquirer 14, the interchange network 16, and the issuer 18 may be coupled together in communication via a network 20. The network 20 may include, for example and without limitation, one or more of a local area network (LAN), a wide area network (WAN) (e.g., the Internet, etc.), a mobile network, a virtual network, and/or any other suitable public and/or private network capable of facilitating communication among the merchant 12, the acquirer 14, the interchange network 16, and/or the issuer 18. In some embodiments, the network 20 may include more than one type of network, such as a private payment transaction network provided by the interchange network 16 to the acquirer 14 and the issuer 18 and, separately, the public Internet, which may facilitate communication between the merchant 12, the interchange network 16, the acquirer 14, and a consumer 22 (also referred to as a “customer,” “cardholder,” and “user”), etc.

In the example system 10, a financial institution called the “issuer,” such as the issuer 18, issues a transaction card account 28, such as a consumer credit card or a debit card, to the consumer 22. The consumer 22 uses the transaction card account 28 to tender payment for a purchase from a merchant, such as the merchant 12. The consumer 22 may input information from the transaction card account 28 into a vehicle system 32 and store the information in a digital wallet 40. The information may be stored as digital wallet data (broadly, payment credentials).

The vehicle system 32 may include, for example, a computing device integrated with the electric vehicle 24 or a consumer computing device paired with the electric vehicle 24, such as a cellular telephone, a smart watch or other electronic wearable apparel, a tablet, an implanted smart device, a personal computing device, or any other electronic device capable of two-way digital communications which may be associated with the consumer 22 and the electric vehicle 24. In some embodiments, the vehicle system 32 may be replaced with another computing device suitable for performing the functions disclosed herein

The merchant 12 is typically associated with goods and/or services offered for sale and sold to the consumer 22. In particular, the merchant 12 may be associated with operating a charge point (CP) 34 and/or mobile charging supplier vehicle 36 (also referred to as a charge point or CP) that are configured to provide electrical energy to electric vehicles, such as an electric vehicle 24. The merchant 12 includes, for example, a physical location and/or a virtual location such as an Internet-based storefront.

To accept payment from the consumer 22, for example, with the digital wallet data stored in the digital wallet 40, the merchant 12 must normally establish an account with a financial institution that is part of the system 10. This financial institution is usually called the “merchant bank,” the “acquiring bank,” or the acquirer 14. When the consumer 22 submits payment for a purchase with the vehicle system 32 using the digital wallet 40, for example, the merchant 12 requests authorization from the acquirer 14 for the purchase. The request may be performed over a telephone but is usually performed using a point-of-sale (POS) terminal that reads the consumer's account information from a magnetic stripe, a chip, embossed characters on the transaction card, or digital wallet data. The POS terminal communicates electronically with the transaction processing computers of the acquirer 14. Alternatively, the acquirer 14 may authorize a third party to perform transaction processing on its behalf. In this case, the POS terminal will be configured to communicate with the third party. Such a third party is usually called a “merchant processor,” an “acquiring processor,” or a “third party processor.”

Using the interchange network 16, the computers of the acquirer 14 or the merchant processor will communicate with computers of the issuer 18 to determine whether the consumer's account is in good standing and whether the purchase is covered by the consumer's available credit line or account balance. Based on these determinations, the request for authorization will be declined or accepted. If the request is accepted, a bank network reference number, an authorization code, and/or other transaction identifier(s) that may be used to identify the transaction is issued to the merchant 12.

The interchange network 16 may be configured to process authorization messages, such as ISO® 8583 compliant messages and ISO® 20022 compliant messages. As used herein, “ISO®” includes a series of standards approved by the International Organization for Standardization (ISO is a registered trademark of the International Organization for Standardization of Geneva, Switzerland). ISO 8583 compliant messages are defined by the ISO 8583 standard that governs financial transaction card originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. For example, ISO 20022 compliant messages may include acceptor to issuer card messages (ATICA).

During the authorization process of the system 10, a clearing process is also taking place. During the clearing process, the acquirer 14 provides the issuer 18 with information relating to the sale. No money is exchanged during clearing. Clearing (also referred to as “first presentment”) involves the exchange of data required to identify the consumer's account 28, such as the account number, expiration date, billing address, amount of the sale, and/or other transaction identifiers that may be used to identify the transaction. Along with this data, banks in the United States also include a bank network reference number, such as a Banknet Reference Number used by Mastercard, which identifies the specific transaction. When the issuer 18 receives this data, the issuer 18 posts the amount of sale as a draw against the available credit in the consumer's account 28 and prepares to send payment to the acquirer 14.

When a request for authorization is accepted, the available credit line of the consumer's account 28 is decreased. Normally, a charge for a payment card transaction is not posted immediately to the consumer's account 28 because bankcard associations, such as Mastercard, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on a POS terminal. This may include bundling of approved transactions daily for standard retail purchases. If the consumer 22 cancels a transaction before it is captured, a “void” is generated. If the consumer 22 returns goods after the transaction has been captured, a “credit” is generated. The interchange network 16 and/or the issuer 18 stores the payment card information, such as, and without limitation, a type of merchant, a merchant identifier, a location where the transaction was completed, an amount of purchase, and a date and time of the transaction, in a database 26.

After a transaction is authorized and cleared, the transaction is settled among the merchant 12, the acquirer 14, and the issuer 18. Settlement refers to the transfer of financial data or funds among the merchant 12, the acquirer 14, and the issuer 18 related to the transaction. In some embodiments, transactions are captured and accumulated into a “batch,” which is settled as a group. In other embodiments, the transactions are captured and settled individually or in a group in substantially real-time. More specifically, a transaction is typically settled between the issuer 18 and the interchange network 16, and then between the interchange network 16 and the acquirer 14, and then between the acquirer 14 and the merchant 12.

In some embodiments, the payment card transaction is a card present transaction conducted, for example, by swiping or dipping a payment card at the merchant's POS terminal. Alternatively, the payment card transaction may be a card-not-present transaction conducted, for example, with a payment card stored on file with the merchant 12 or stored as digital wallet data in the digital wallet 40 on a consumer's computing device, such as the vehicle system 32. In the example, the vehicle system 32 and the digital wallet 40 may be integrated with the electric vehicle 24 as an onboard computing system or may include a consumer computing device paired with the electric vehicle 24, such as a cellular telephone, a smart watch or other electronic wearable apparel, a tablet, an implanted smart device, a personal computing device, or any other electronic device capable of two-way digital communications that may be associated with the consumer 22 and the electric vehicle 24.

The vehicle system 32 may additionally be configured to assist the consumer 22 with setting up an account with the merchant 12. During the account setup process, the consumer 22 may transmit account registration information to the merchant 12, via the vehicle system 32. The account registration information may include, for example, and without limitation, payment account data (e.g., a primary account number (PAN), a virtual payment number, limited use number, etc.) and user system identification data (e.g., a vehicle identification number (VIN), Electronic Serial Number (ESN), Mobile Equipment Identifier (MEID), International Mobile Equipment Identity (IMEI) number, and the like). For example, the merchant 12 may receive account registration information from the vehicle system 32 identifying the vehicle system 32 and a payment account or PAN associated with the consumer 22. The consumer 22 may, for example, set up the account with the merchant 12 by providing the account registration information and generating a login identifier (i.e., a UserID) and a password used when logging into an application for communicating with the merchant 12. The consumer 22 may transmit various information or data to the merchant 12 via an application, which may be stored on, partially stored on, or accessed via a web-browser of the vehicle system 32. The information or data transmitted by the consumer 22 to the merchant 12 may also include, for example, authentication information associated with the consumer's PAN, biometrics of the consumer, and/or contact information. The contact information may include one or more ways to communicate with the consumer 22, including, for example, via a push notification associated with the application, a short messaging service (SMS) message, an email message, a telephone number, and the like. The merchant 12 may generate a new account profile or update an existing account profile for the account associated with the account registration information received from the vehicle system 32. Payment information associated with the account is stored in the digital wallet 40. Alternatively or in addition, in some embodiments, another consumer computing device (not shown), such as a cellular telephone, a smart watch or other electronic wearable apparel, a tablet, an implanted smart device, a personal computing device, etc., capable of capable of two-way digital communications via the network 20 may be used by the consumer 22 to setup the account with the merchant 12.

In the example embodiment, the interchange network 16 includes a server system 30 coupled in communication with the merchant 12 and associated CPs 34 and 36, the acquirer 14, and the issuer 18. The server system 30 is also coupled in communication with a one or more client systems, such as the vehicle system 32 and other user or vehicle systems. In one embodiment, the vehicle system 32 is a computing device that includes a web browser or interface, such that the server system 30 is accessible to the vehicle system 32 using the Internet. The vehicle system 32 is interconnected to the Internet through one or more interfaces including, for example, a network, such as: a LAN or WAN, dial-in-connections, cable modems, and/or special high-speed Integrated Services Digital Network (ISDN) lines; and/or with a mobile phone network, such as Global System for Mobile communications (GSM), 3G, 4G, 5G, or other mobile data network; and/or Worldwide Interoperability for Microwave Access (WiMax) and the like. The vehicle system 32 can be any device capable of interconnecting to the Internet including an Internet connected phone, a PDA, or any other suitable web-based connectable equipment.

The one or more CPs 34 and 36 may be connected to the merchant 12 and to the server system 30. The CPs 34 and 36 may be interconnected to the Internet (or any other network that allows the CPs 34 and 36 to communicate as described herein) through any one or more suitable interfaces including, for example, a network, such as: a LAN or WAN, dial-in-connections, cable modems, and/or special high-speed Integrated Services Digital Network (ISDN) lines; and/or with a mobile phone network, such as Global System for Mobile communications (GSM), 3G, 4G, 5G, or other mobile data network; and/or Worldwide Interoperability for Microwave Access (WiMax) and the like. Each of the CPs 34 and 36 may include any device capable of interconnecting to the Internet and including an input device capable of reading information received from the digital wallet 40 of the vehicle system 32.

In the example embodiment, the server system 30 is connected to the database 26, which is configured to store information on a variety of matters, including account information associated with consumers, such as the consumer 22. In one embodiment, the database 26 is a centralized database stored on the server system 30. In an alternative embodiment, the database 26 is stored remotely from the server system 30 and may be a distributed or non-centralized database. In an embodiment, the database 26 may include a single database having separated sections or partitions or may include multiple databases, each being separate from each other. The database 26 may store transaction data generated as part of sales activities and savings activities conducted over the processing network including data relating to merchants, account holders or customers, issuers, acquirers, savings amounts, savings account information, and/or purchases made. The database 26 may also store account data including at least one of a consumer name, a consumer address, an account number, and other account identifier. The database 26 may also store merchant data including a merchant identifier that identifies each merchant registered to use the network, and instructions for settling transactions including merchant bank account information. The database 26 may also store purchase data associated with items being purchased by a consumer from a merchant, and authorization request data. The database 26 may also store device information, payment card information, and other data involved with processing transactions between one or more parties.

It is noted that the system 10 may include more, fewer, or alternative components and/or perform more, fewer, or alternative actions, including those discussed elsewhere herein.

### Exemplary Computer Systems

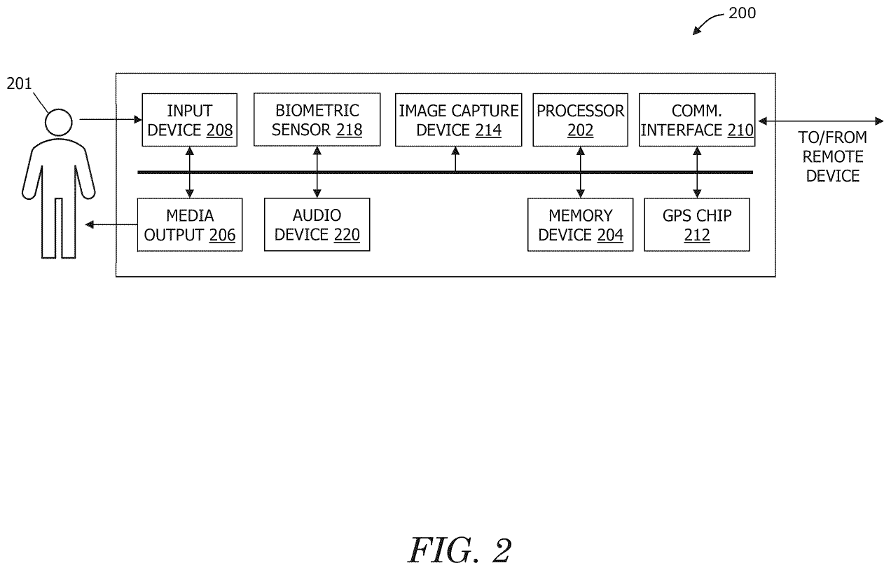

FIG. 2 is an example configuration of a computing system 200. In some embodiments, the computing system 200 is the vehicle system 32 (shown in FIG. 1) operated by a user 201, such as the consumer 22 (shown in FIG. 1).

In the example, the computing system 200 includes one or more processors 202 (e.g., in a multi-core configuration) for executing computer readable instructions. The instructions may be executed within a variety of different operating systems (OS) on the computing system 200, such as UNIX, LINUX, Microsoft Windows®, etc. More specifically, the instructions may cause various data manipulations on data stored in a memory device 204 (e.g., create, read, write, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.). In some embodiments, the executable instructions are stored in the memory device 204. The memory device 204 is any device allowing information such as digital wallet data, executable instructions, and the like to be stored thereon and retrieved therefrom. The memory device 204 includes one or more computer readable media.

In the example embodiment, the processor 202 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

In some embodiments, the computing system 200 includes a GPS chip 212. A location of the computing system 200 can be obtained through conventional methods, such as a location service (e.g., global positioning system (GPS) service) in the computing system 200, “ping” data that includes geotemporal data, from cell location register information held by a telecommunications provider to which the computing system 200 is connected, and the like. In various embodiments, the GPS chip 212 can be part of or separate from the processor 202 to enable the location of the computing system 200 to be determined.

The computing system 200 also includes at least one media output component 206 for presenting information to the user 201. The media output component 206 is any component capable of conveying information to the user 201. In some embodiments, the media output component 206 includes an output adapter such as a video adapter and/or an audio adapter. An output adapter is operatively coupled to the processor 202 and operatively connectable to an output device such as a display device, a liquid crystal display (LCD), organic light emitting diode (OLED) display, or “electronic ink” display, or an audio output device, a speaker, or headphones.

In some embodiments, the computing system 200 includes an input device 208 for receiving input from the user 201. The input device 208 may include, for example, a touch sensitive panel, a touch pad, a touch screen, a stylus, a gyroscope, an accelerometer, a position detector, a keyboard, a pointing device, a mouse, or an audio input device. A single component, such as a touch screen, may function as both an output device of the media output component 206 and the input device 208.

The computing system 200 may also include a communication interface 210, which is communicatively connectable to a remote computing device, such as the server system 30 (shown in FIG. 1) and/or the CPs 34 and 36 (shown in FIG. 1). The communication interface 210 may include, for example, a wired or wireless network adapter or a wireless data transmitter or transceiver for use with Bluetooth communication, radio frequency (RF) communication, AM/FM frequency broadcasts, near field communication (NFC); and/or with a mobile phone network, such as Global System for Mobile communications (GSM), 3G, 4G, 5G, or other mobile data network; and/or Worldwide Interoperability for Microwave Access (WiMax) and the like.

Stored in the memory device 204 are, for example, computer readable instructions for providing a user interface to the user 201 via the media output component 206 and, optionally, receiving and processing input from the input device 208, communication interface 210, an image capture device 214, a biometric sensor 218, and/or an audio device 220. A user interface may include, among other possibilities, a web browser and a client application. Web browsers enable users, such as the user 201, to display and interact with media and other information typically embedded on a web page or a website from the server system 30. A client application allows the user 201 to interact with, for example, a server application from the server system 30 and/or an interface from the CPs 34 and 36 or merchant 12. In the example embodiment, the memory device 204 may store digital wallet data corresponding to a digital wallet, such as the digital wallet 40 (shown in FIG. 1).

The computing system 200 may also include the image capture device 214. The image capture device 214 may include a camera or other optical sensor and lens combination capable of capturing light, an image, iris scan, and the like. In various embodiments, the image capture device 214 may be integrated in a housing or body (not shown) of the computing system 200 and/or the electric vehicle 24. When the image capture device 214 captures an image, the image capture device 214 may store the image data in a data file, either in a raw or compressed format, in the memory device 204.

The computing system 200 may also include the biometric sensor 218. The biometric sensor 218 includes, for example, a fingerprint scanner configured to scan or read a user's fingerprint when a user's finger is placed on the fingerprint scanner. In this manner, a user can register (i.e., store) his or her fingerprint data on the computing system 200 for subsequently authenticating the identity of the user. While a user's fingerprint is described herein in relation to biometric data, it is contemplated that the biometric sensor 218 can optionally include a camera, an optical imager, a retinal scanner, a microphone, a heart rate monitor, etc. Thus, the biometric data obtained via the biometric sensor 218 may include fingerprint data, facial feature data, retinal scan data, vein pattern data, heart rate data, etc. Thus, it is noted that the biometric data described herein are not limited to a particular biometric data type.

The computing system 200 may also include an audio device 220. The audio device 220 may include, for example, and without limitation, a speaker and related components capable of broadcasting streaming and/or recorded audio and may also include a microphone. The microphone facilitates capturing audio through the computing system 200.

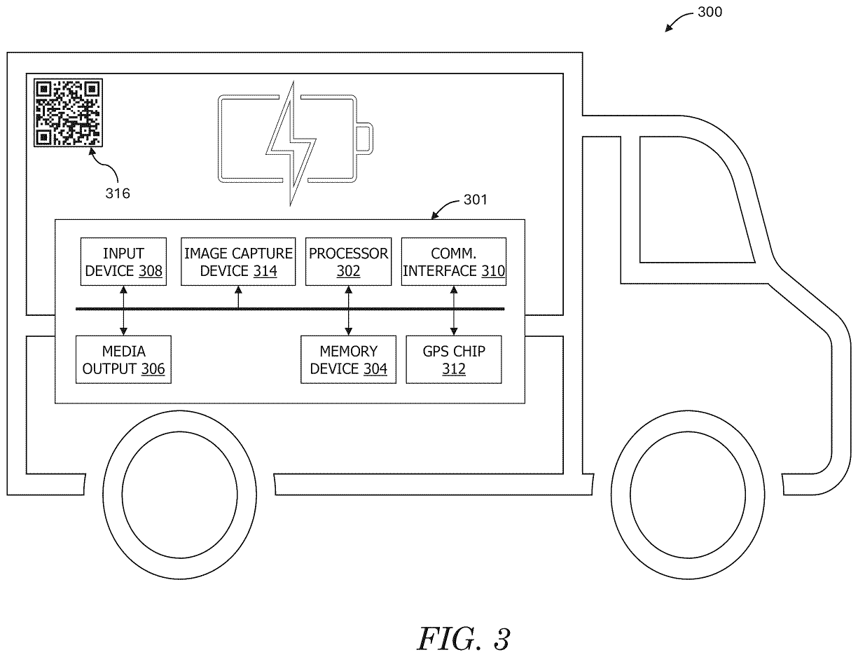

FIG. 3 is an example configuration of a mobile charging supplier vehicle 300 including a computing system 301. In some embodiments, the vehicle 300 is the mobile charging supplier vehicle 36 (shown in FIG. 1). The computing system 301 may also be a computing system integrated with the CP 34.

In the example, the computing system 301 includes a processor 302 for executing instructions. In some embodiments, executable instructions are stored in a memory device 304. The processor 302 includes one or more processing units, for example, defining a multi-core configuration. The memory device 304 is any device allowing information such as payment transaction data, executable instructions, and the like to be stored thereon and retrieved therefrom. The memory device 304 includes one or more computer readable media.

In the example embodiment, the processor 302 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

In some embodiments, the computing system 301 includes a GPS chip 312. A location of the mobile charging supplier vehicle 300 can be obtained through conventional methods, such as a location service (e.g., global positioning system (GPS) service) in the computing system 301, “ping” data that includes geotemporal data, from cell location register information held by a telecommunications provider to which the computing system 301 is connected, and the like. In various embodiments, the GPS chip 312 can be part of or separate from the processor 302 to enable the location of the computing system 301 to be determined.

The computing system 301 preferably may also include at least one media output component 306 for presenting information to a user. The media output component 306 is any component capable of conveying information to a user. In some embodiments, the media output component 306 includes an output adapter such as a video adapter and/or an audio adapter. An output adapter is operatively coupled to the processor 302 and operatively connectable to an output device such as a display device, a liquid crystal display (LCD), organic light emitting diode (OLED) display, or “electronic ink” display, or an audio output device, a speaker, or headphones.

In some embodiments, the computing system 301 includes an input device 308 for receiving input from a user. The input device 308 may include, for example, a touch sensitive panel, a touch pad, a touch screen, a stylus, a gyroscope, an accelerometer, a position detector, a keyboard, a pointing device, a mouse, or an audio input device. A single component such as a touch screen may function as both an output device of the media output component 306 and the input device 308.

The computing system 301 may also include a communication interface 310, which is communicatively connectable to a remote device, such as the server system 30 (shown in FIG. 1) and/or the merchant 12 (shown in FIG. 1), and/or which may broadcast wireless signals, such as AM/FM frequencies broadcasts. The communication interface 310 may include, for example, a wired or wireless network adapter or a wireless data transmitter or transceiver for use with Bluetooth communication, radio frequency (RF) communication, AM/FM frequency broadcasts, near field communication (NFC); and/or with a mobile phone network, such as Global System for Mobile communications (GSM), 3G, 4G, 5G, or other mobile data network; and/or Worldwide Interoperability for Microwave Access (WiMax) and the like.

In a preferred embodiment, stored in the memory device 304 are, for example, computer readable instructions for providing a user interface to a user, for example, via the media output component 306 and, optionally, receiving and processing input from the input device 308, the communication interface 310, and/or an image capture device 314. A user interface may include, among other possibilities, a web browser and a client application. Web browsers enable users to view and interact with media and other information typically embedded on a web page or a website, for example, from the server system 30. A client application allows a user to interact with, for example, a server application from the server system 30 and/or the merchant 12. In the example embodiment, the memory device 304 may store digital wallet data corresponding to a digital wallet, such as the digital wallet 40 (shown in FIG. 1).

The computing system 301 may also include the image capture device 314. The image capture device 314 may include a camera or other optical sensor and lens combination capable of capturing light, an image, iris scan, and the like. In various embodiments, the image capture device 314 may be integrated in a housing or body (not shown) of the mobile charging supplier vehicle 300. When the image capture device 314 captures an image, the image capture device 314 may store the image data in a data file, either in a raw or compressed format, in the memory device 304.

The mobile charging supplier vehicle 300 may also include a machine-readable code 316 (e.g., a bar code, quick response (QR) code, and the like) printed or otherwise presented on a housing or body (not shown) of the mobile charging supplier vehicle 300. In an example, the machine-readable code 316 is a QR code. A QR code is a two-dimensional barcode or matrix barcode that is defined by the international standard ISO/IEC 18004:2015. A QR code includes three distinctive marks at different corners of the QR code image and one or more smaller marks proximate a fourth corner to normalize the image for size, orientation, and angle of viewing. In addition, dispersed within the four corners of the QR code are a plurality of small dots that can be converted to binary numbers and validated with an error-correcting algorithm. The binary number includes data that is encoded within the QR code. In one suitable embodiment, the data encoded in the QR code includes a merchant identifier, a mobile charging supplier vehicle identifier, and/or other information associated with the merchant 12 and/or the manner in which a transaction with the mobile charging supplier vehicle 300 is performed. While the machine-readable code described herein is in reference to a QR code, the disclosure contemplates that any type of machine-readable code may be used that enables the system 10 to function as described herein. For example, the machine-readable code may include one or more of one dimensional barcode formats, such as a UPC, CODE39, EAN 8, or EAN 13, or other two-dimensional formats, such as PDF417 or Datamatrix.

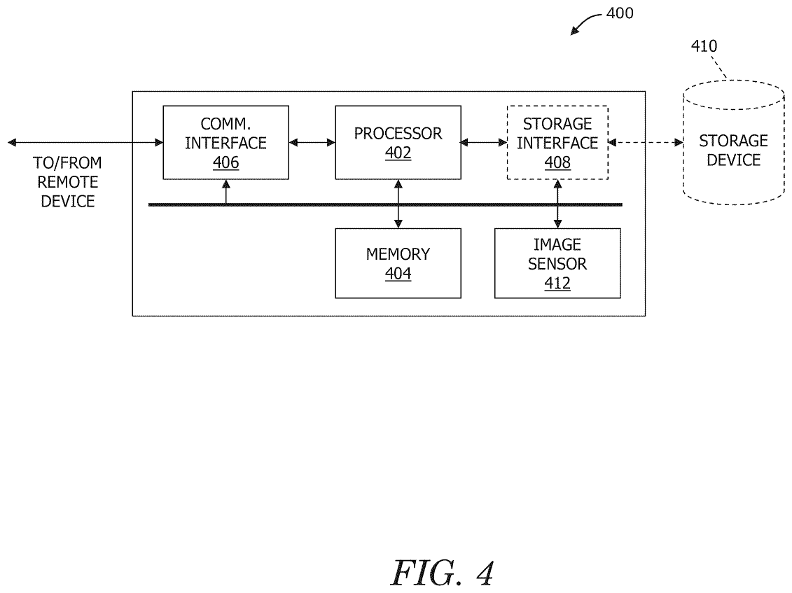

FIG. 4 is an example configuration of a server system 400, such as the server system 30 (shown in FIG. 1). The server system 400 includes, but is not limited to, the database 26 (shown in FIG. 1).

In the example embodiment, the server system 400 includes a processor 402 for executing instructions. The server system 400 further includes a memory 404, in which the instructions may be stored. The processor 402 includes one or more processing units (e.g., in a multi-core configuration) for executing the instructions. The instructions may be executed within a variety of different operating systems on the server system 400, such as UNIX, LINUX, Microsoft Windows®, etc. More specifically, the instructions may cause various data manipulations on data stored in a storage device 410 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 402 is operatively coupled to a communication interface 406 such that the server system 400 can communicate with remote computing devices, such as a computing systems 200 and 300 (shown in FIGS. 2 and 3, respectively) or another server system. For example, the communication interface 406 may receive communications from the vehicle system 32 via the network 20 (shown in FIG. 1), such as the Internet.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is similar to the database 26. For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory area 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

### Computer-Implemented Methods

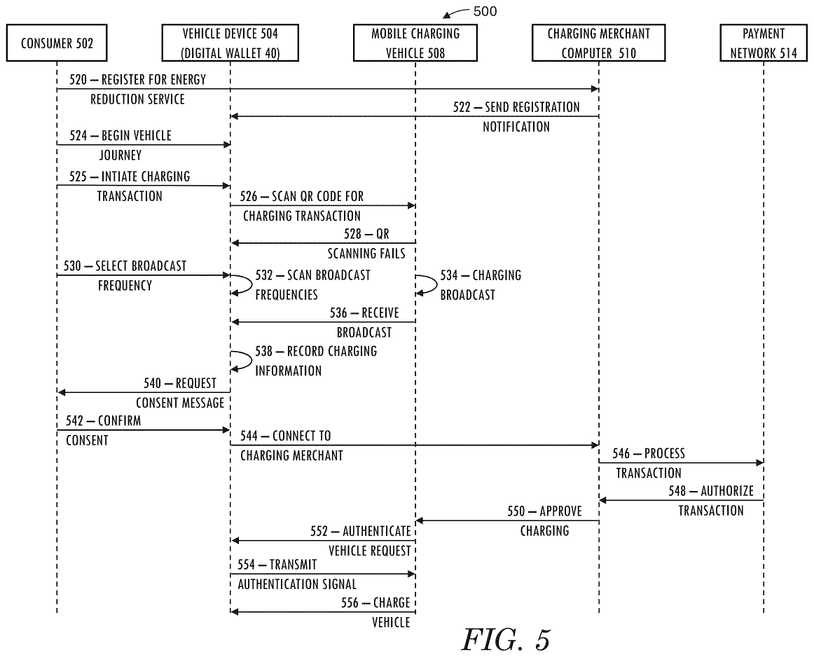

FIG. 5 is a process flow diagram for a process 500 for an electrical energy charging transaction between a consumer 502 (e.g., the consumer 22 (shown in FIG. 1)) and a charging supplier merchant (e.g., the merchant 12 (shown in FIG. 1)), in accordance with an aspect of the present disclosure. The process 500 is described below, for ease of reference, as being executed by exemplary devices and components introduced with the embodiments illustrated in FIGS. 1-4. In one embodiment, the process 500 may be implemented by the system 10 (shown in FIG. 1). The process 500 may be implemented on other computing devices and/or systems through the utilization of processors, transceivers, hardware, software, firmware, or combinations thereof. A person having ordinary skill will further appreciate that responsibility for all or some of the actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the operations outlined herein. The program(s) stored on the computer-readable medium(s) may instruct the processor or processing units to perform additional, fewer, or alternative actions, including those discussed elsewhere herein.

As shown in FIG. 5 at 520, the consumer 502 may register for an electric vehicle charging service account with the charging supplier merchant, for example, by registering via the charging supplier merchant computing device 510. For example, the charging supplier merchant computing device 510 may facilitate the registration process by receiving or capturing consumer details, verifying consumer identity, and vehicle information, such as a vehicle identification number (VIN). The consumer details may be securely transmitted to the charging supplier merchant computing device 510 by the consumer 502 using, for example, a consumer vehicle computing device 504 or other consumer computing device, such as a cellular telephone, a smart watch or other electronic wearable apparel, a tablet, an implanted smart device, a personal computing device, etc. The consumer 502 may create an account or log in to an existing account on the charging supplier merchant's website or app and add their payment information, such as Credit/Debit card details (e.g., card number, expiration date, CVV, etc.) in the account's payment settings. The consumer 502 may opt-in for card-on-file (COF) storage. Instead of storing the consumer's actual card number, the charging supplier merchant may request that a payment network 514 tokenize the consumer's card information. The token received from the payment network 514, not the actual card data, may be stored by the charging supplier merchant in a database with the consumer's electric vehicle charging service account. Once stored, the charging supplier merchant can use the COF data to process future transactions without requiring the consumer 502 to re-enter their card information.

At 522, the charging supplier merchant computing device 510 may send a notification of registration to the consumer 502, and more preferably, to the consumer vehicle computing device 504. The notification may include, for example, a unique identifier for the consumer 502 and detailed instructions on using the electric vehicle charging service account to process a vehicle charging transaction to charge the consumer's vehicle, such as the electrical vehicle 24 (shown in FIG. 1). In an embodiment, the communication may be encrypted to ensure security and may be transmitted via multiple channels such as email, SMS, push notification, a dedicated mobile application, and the like.

At 524, the consumer 502 may begin a journey in the consumer's vehicle, such as the vehicle 24 (shown in FIG. 1). During the journey, the consumer 502 may identify a mobile charging vehicle 508 (which may include the mobile charging supplier vehicle 300 (shown in FIG. 3)), for example, using visual cues.

At 525, upon approaching the mobile charging vehicle 508, the consumer 502 may initiate a charging transaction, for example, via input to the consumer vehicle computing device 504. This transaction initiation may be provided through various input methods to the consumer vehicle computing device 504, such as voice activation (e.g., via the audio device 220 (shown in FIG. 2)), one or more push buttons in the vehicle 24, one or more switches on a steering wheel of the vehicle 24, and/or via a biometric sensor integrated into the vehicle 24, and more particularly, into the consumer vehicle computing device 504 (e.g., the biometric sensor 218 (shown in FIG. 2)). Biometric input by the consumer may include, for example, a fingerprint, facial recognition, retina scan, etc.

In an example, the mobile charging vehicle 508 may display a machine-readable code, such as the machine-readable code 316 (shown in FIG. 3), which the consumer vehicle computing device 504 may attempt to scan. In an embodiment, the machine-readable code is a QR code.

At 526, the consumer vehicle computing device 504 may scan the QR code presented by the mobile charging vehicle 508. The QR code may be displayed on the mobile charging vehicle 508. The consumer vehicle computing device 504 may scan the QR code using an image capture device, such as the image capture device 214 (shown in FIG. 2). This QR code may provide vehicle charging information, such as the charging merchant, an available charge, and the cost/rate for charging the consumer's vehicle. Successful scanning of the QR code may initiate a vehicle charging payment transaction.

At 528, the consumer vehicle computing device 504 may notify the consumer 502 that the scanning of the QR code failed. For example, the QR code may be partially visible, obscured, hidden, etc. from view of the vehicle's image capture device, such as the image capture device 214. This may not allow the consumer vehicle computing device 504 to receive the transaction information needed to perform a QR code transaction. In such an instance, the consumer vehicle computing device 504 may present a notification to the consumer 502 of such failure, for example, on a display of the consumer vehicle computing device 504.

At 530, in response to the QR code scanning failure, the consumer 502 may select a pre-defined AM/FM radio frequency in the vehicle using the consumer vehicle computing device 504. In the example, the consumer vehicle computing device 504 uses AM/FM radio frequencies for vehicle-to-vehicle communication. The consumer 502 may pre-program one or more AM/FM radio frequencies into the consumer vehicle computing device 504, where the AM/FM radio frequencies may be associated with a charging merchant and/or mobile charging vehicle 508. Alternatively, the consumer 502 may tune the consumer vehicle computing device 504 to an AM/FM radio frequency that is displayed on the mobile charging vehicle 508.

At 532, in response to the QR code scanning failure, the consumer vehicle computing device 504 may tune to and scan the selected AM/FM radio frequency to detect a broadcast, for example, from the mobile charging vehicle 508.

At 534, the mobile charging vehicle 508, equipped with a radio frequency transmitter (such as the communication interface 310 (shown in FIG. 3)), may broadcast charging information on the pre-defined AM/FM radio frequency. The charging information may include, for example, a merchant identifier, a mobile charging supplier vehicle identifier, and/or other information associated with the merchant 12 and/or the manner in which a transaction with the mobile charging vehicle 508 is performed. The broadcast may occur on the pre-defined AM/FM radio frequency, indicating to nearby consumer vehicles that charging services are available. In an embodiment, each mobile charging vehicle broadcasts on a dedicated AM/FM radio frequency. When the consumer 502 tunes the consumer vehicle computing device 504 into this frequency, it facilitates establishing a communication link between the consumer vehicle computing device 504 and the mobile charging vehicle 508, as long as the vehicles are within a defined range.

At 536, the consumer vehicle computing device 504 may detect the charging information broadcast. Upon detecting the broadcast, the consumer vehicle computing device 504 may receive the AM/FM radio frequency signal, which includes the charging information. At 538, the consumer vehicle computing device 504 may record the charging information for further processing. In the example, unlike conventional radio communication, which is one-directional, the process 500 incorporates two-way communication via, for example, modulated radio signals. The mobile charging vehicle 508 may send out a broadcast message, and once the consumer vehicle computing device 504 is tuned into the pre-defined station, it communicates back using low-power transmission on the same frequency or a nearby frequency. This transmission can include encrypted account and/or transaction data, energy requests, and confirmation signals, all facilitating the energy transfer process. For example, the consumer vehicle computing device 504 may transmit its unique identification code, available balance in the digital wallet 40 (shown in FIG. 1), and a confirmation to begin an energy transfer process. In some embodiments where multiple vehicles may be involved, or where a direct radio signal cannot be established due to distance, the process 500 may employ mesh networking techniques. This may allow messages and energy transfer requests to propagate across a series of connected vehicles, effectively extending the communication range and allowing additional vehicles to connect to the mobile charging vehicle 508 through relay vehicles.

At 540, the consumer vehicle computing device 504 may present the consumer 502 with a charging connection consent request and/or docking information after receiving the charging information and in response to recording the charging information for further processing. The charging connection consent request may include a request for consent from the consumer 502 to initiate the vehicle charging. The docking information may include navigational details for altering the course of the consumer's vehicle 24 to enter a charging range or geo-fence of the mobile charging vehicle 508. The charging connection consent request and/or docking information may be presented on a display of the consumer vehicle computing device 504, such as the media output component 206 (shown in FIG. 2).

At 542, the consumer 502 may confirm consent to proceed with the charging transaction. This consent can be provided through various input methods to the consumer vehicle computing device 504, such as voice activation (e.g., via the audio device 220 (shown in FIG. 2)), one or more push buttons in the vehicle 24, one or more switches on a steering wheel of the vehicle 24, and/or via a biometric sensor integrated into the vehicle 24, and more particularly, into the consumer vehicle computing device 504 (e.g., the biometric sensor 218 (shown in FIG. 2)). Biometric input by the consumer may include, for example, a fingerprint, facial recognition, retina scan, etc.

Upon receiving the consumer's consent, at 544, the consumer vehicle computing device 504 transmits a charging connection message to the charging supplier merchant computing device 510 associated with the mobile charging vehicle 508. The charging connection message may be securely transmitted via an application programming interface (API) call over a network, such as the Internet, using public key encryption to ensure that only the charging supplier merchant computing device 510 can decrypt charging connection message. The charging connection message may include the unique consumer identifier associated with the consumer's registered account (discussed above at 520 and 522), the VIN of the consumer's vehicle 24 associated with the consumer account, and the charging information recorded by the consumer vehicle computing device 504 at 538 above.

After receiving the charging connection message from the consumer 502, the charging supplier merchant computing device 510 may send an authorization request to the payment network 514 at 546. The authorization request may include a transaction amount due for the charging transaction and payment information associated with the consumer's card on file. For example, the payment information may include the token stored by the charging supplier merchant for the consumer's account. In an embodiment, a server of the payment network, such as the server system 30 (shown in FIG. 1), may generate transaction information based on the authorization request and transmit the transaction information to an issuer associated with the consumer's payment information, such as the issuer 18. The issuer 18 may process the transaction information to pre-authorize the payment amount included in the transaction information. The issuer 18 may parse the transaction information to identify a PAN associated with the payment account of the consumer 502. The issuer 18 may subsequently determine whether the payment account 28 includes sufficient available funds for processing the transaction. If the payment account 28 includes sufficient funds to complete the transaction, the issuer 18 may determine that pre-authorization is successful and may send a pre-authorization success message to the server system 30. Otherwise, the issuer 18 may determine that the pre-authorization has failed and may send a pre-authorization failure message to the server system 30.

At 548, upon receiving a pre-authorization success message from the issuer 18, the server system 30 may send a message to the charging supplier merchant computing device 510 (via the acquirer 14 in some embodiments) indicating that the pre-authorization was successful. If the message received by the charging supplier merchant computing device 510 indicates that pre-authorization was successful, at 550, the charging supplier merchant computing device 510 may responsively authorize vehicle charging and send an instruction to the mobile charging vehicle 508 to begin charging the consumer vehicle 24. The approval may be based on the successful completion of the payment transaction and the availability of charging capacity. The charging supplier merchant computing device 510 may provide a confirmation to the consumer 502, for example, via the consumer vehicle computing device 504.

Alternatively, upon receiving a pre-authorization failure message from the issuer 18, the server system 30 may send a failure message to the consumer vehicle computing device 504 indicating that the pre-authorization was not successful. Upon receiving the failure message, the consumer 502 may select a different payment method stored in the digital wallet 40 and re-submit the transaction information (including information identifying the different payment method); otherwise, the transaction is declined.

At 552, the mobile charging vehicle 508 may establish a secure connection with the consumer's vehicle 24 to authenticate the vehicle, for example, prior to initiating charging. For example, authentication may involve the mobile charging vehicle 508 sending a request for the consumer vehicle computing device 504 to have the vehicle 24 perform a specific action, such as one of flashing its headlights in a particular pattern, transmitting a particular code via Bluetooth or another wireless transmission technology, etc. In response, at 554, the consumer vehicle computing device 504 may transmit the requested authentication signal in the manner requested by the mobile charging vehicle 508. The mobile charging vehicle 508 may then use an image capture device to verify the flash pattern from the vehicle 24 or perform a geo-fenced Bluetooth scan to confirm the action and authenticate the consumer's vehicle 24. It is noted that other vehicle authentication techniques may be employed to ensure that the correct vehicle will receive charging from the mobile charging vehicle 508.

After the mobile charging vehicle 508 authenticates the vehicle 24, the charging supplier vehicle may begin the charging process at 556. The secure connection ensures that the charging is conducted only with the authorized consumer vehicle 24. The charging process may be permitted and monitored by the consumer vehicle computing device 504. The charging process may also be monitored by the mobile charging vehicle 508. The consumer 502 may be notified of the charging status and the estimated time to complete the charging. In some embodiments, the mobile charging vehicle 508 may also provide additional services such as battery health diagnostics and maintenance recommendations. In some embodiments, after charging is complete, the mobile charging vehicle 508 may transmit a report to the charging supplier merchant computing device 510 indicating a final amount to charge the payment account 28 of the consumer 502.

Although FIG. 5 shows example steps of process 500, in some implementations, process 500 may include additional steps, fewer steps, different steps, or differently arranged steps than those depicted in FIG. 5. Additionally or alternatively, two or more of the steps of process 500 may be performed in parallel. For example, the scanning for the broadcast signal by the consumer vehicle computing device 504 and the broadcasting of the charging information by the mobile charging vehicle 508 may be performed substantially simultaneously. The process 500 may also be customized based on the consumer's and/or merchant's preferences and the specific capabilities of the devices involved.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this application, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the term “database” includes either a body of data, a relational database management system (RDBMS), or both. As used herein, a database includes, for example, and without limitation, a collection of data including hierarchical databases, relational databases, flat file databases, object-relational databases, object-oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL® (PostgreSQL is a registered trademark of PostgreSQL Community Association of Canada, Toronto, Canada). However, any database may be used that enables the systems and methods to operate as described herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor includes a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

1. A system comprising:
a consumer vehicle associated with a consumer,
the consumer vehicle including a consumer vehicle computing device,
the consumer vehicle computing device comprising:
a one or more first processors; and
a first memory having first computer-executable instructions stored thereon, which when executed by the one or more first processors, causes the one or more first processors to:
identify a mobile charging vehicle displaying a machine-readable code, the mobile charging vehicle being associated with a charging merchant;
scan the machine-readable code;
detect failure in scanning the machine-readable code;
in response to the scanning failure, select an AM/FM radio frequency in the consumer vehicle;
receive a radio broadcast transmitted by the mobile charging vehicle on the AM/FM radio frequency, the radio broadcast including charging information;
transmit a charging connection message to the charging merchant, the charging connection message including the charging information received via the radio broadcast; and
permit the consumer vehicle to receive charging from the mobile charging vehicle.

2. The system in accordance with claim 1,
the first computer-executable instructions causing the one or more first processors to register the consumer for an electric vehicle charging service account with a charging merchant,
the system further comprising a charging merchant computing device associated with the charging merchant,
the charging merchant computing device comprising:
a one or more second processors; and
a second memory having second computer-executable instructions stored thereon, which when executed by the one or more second processors, causes the one or more second processors, as part of the registering the consumer for the electric vehicle charging service account, to:
receive payment information associated with the consumer from the consumer vehicle computing device;
request, from a payment network, that the payment information be tokenized;
receive, from the payment network, a token associated with the payment information; and
store the token in a database.

3. The system in accordance with claim 1,
the machine-readable code including a QR code displayed on the mobile charging vehicle.

4. The system in accordance with claim 1,
the first computer-executable instructions causing the one or more first processors to:
record the charging information from the radio broadcast transmitted by the mobile charging vehicle.

5. The system in accordance with claim 1,
the AM/FM radio frequency being a dedicated AM/FM radio frequency associated with the mobile charging vehicle.

6. The system in accordance with claim 1,
the charging connection message further including a vehicle identification number (VIN) of the consumer vehicle,
the first computer-executable instructions causing the one or more first processors, as part of transmitting the charging connection message, to:
transmit the charging connection message via an application programming interface (API) using public key encryption.

7. The system in accordance with claim 1, further comprising:
a mobile charging vehicle computing device associated with the mobile charging vehicle,
the mobile charging vehicle computing device comprising:
a one or more third processors; and
a third memory having third computer-executable instructions stored thereon, which when executed by the one or more third processors, causes the one or more third processors to:
authenticate the consumer vehicle; and
in response, initiate charging of the consumer vehicle.

8. The system in accordance with claim 7,
the step of authenticating the consumer vehicle including:
the third computer-executable instructions causing the one or more third processors to transmit a request to the consumer vehicle computing device to perform a specified action; and
the first computer-executable instructions causing the one or more first processors to transmit an authentication signal in response to the request.

9. The system in accordance with claim 8,
the specified action including one of the following: the consumer vehicle flashing its headlights in a specified pattern; and transmitting, via the consumer vehicle computing device, a code via a wireless transmission technology.

10. The system in accordance with claim 1,
the first computer-executable instructions causing the one or more first processors to:
after receiving the charging information, present, to the consumer, a consent request, the consent request including a request for consent from the consumer to initiate the vehicle charging; and
receive consent to initiate the vehicle charging via one or more of the following input mechanisms: a voice command; a touch interface on the consumer vehicle computing device; a push-button or switch in the consumer vehicle; and biometric data input via a biometric sensor.

11. A method comprising:
identifying, by a consumer vehicle computing device in a consumer vehicle, a mobile charging vehicle displaying a machine-readable code, the mobile charging vehicle being associated with a charging merchant;
scanning, by the consumer vehicle computing device, the machine-readable code;
detecting, by the consumer vehicle computing device, failure in scanning the machine-readable code;
in response to the scanning failure, selecting, by the consumer vehicle computing device, an AM/FM radio frequency in the consumer vehicle;
receiving, by the consumer vehicle computing device, a radio broadcast transmitted by the mobile charging vehicle on the AM/FM radio frequency, the radio broadcast including charging information;
transmitting, by the consumer vehicle computing device, a charging connection message to the charging merchant, the charging connection message including the charging information received via the radio broadcast; and
permitting the consumer vehicle to receive charging from the mobile charging vehicle.

12. The method in accordance with claim 11, further comprising:
registering, via the consumer vehicle computing device, a consumer for an electric vehicle charging service account with a charging merchant, including:
receiving, by a charging merchant computing device associated with the charging merchant, payment information associated with the consumer;
requesting, by the charging merchant computing device from a payment network, that the payment information be tokenized;
receiving, by the charging merchant computing device from the payment network, a token associated with the payment information; and
storing, by the charging merchant computing device, the token in a database.

13. The method in accordance with claim 11, wherein the machine-readable code is a QR code displayed on the mobile charging vehicle.

14. The method in accordance with claim 11, further comprising:
recording, by the consumer vehicle computing device, the charging information from the radio broadcast transmitted by the mobile charging vehicle.

15. The method in accordance with claim 11,
the AM/FM radio frequency being a dedicated AM/FM radio frequency associated with the mobile charging vehicle.

16. The method in accordance with claim 11,
the charging connection message further including a vehicle identification number (VIN) of the consumer vehicle,
the step of transmitting the charging connection message including transmitting the charging connection message via an application programming interface (API) using public key encryption.

17. The method in accordance with claim 11, further comprising:
authenticating, by a mobile charging vehicle computing device associated with the mobile charging vehicle, the consumer vehicle; and
in response, initiating charging of the consumer vehicle by the mobile charging vehicle computing device.

18. The method in accordance with claim 17,
the authenticating including:
transmitting, by the mobile charging vehicle computing device, a request to the consumer vehicle computing device to perform a specified action; and
transmitting, by the consumer vehicle computing device, an authentication signal in response to the request.

19. The method in accordance with claim 18,
the specified action including one of the following: the consumer vehicle flashing its headlights in a specified pattern; and transmitting, via the consumer vehicle computing device, a code via a wireless transmission technology.

20. The method in accordance with claim 11, further comprising:
after receiving the charging information, presenting, to the consumer by the consumer vehicle computing device, a consent request, the consent request including a request for consent from the consumer to initiate the vehicle charging; and
receiving, by the consumer vehicle computing device, consent to initiate the vehicle charging via one or more of the following input mechanisms: a voice command; a touch interface on the consumer vehicle computing device; a push-button or switch in the consumer vehicle; and biometric data input via a biometric sensor.
